(19) United States
(12) Patent Application Publication
(10) Pub. No.: US 2009/0097235 A1
(43) Pub. Date: Apr. 16, 2009

(54) Multi-purpose flashlight

(76) Inventor: Frank Chambers, Mt. Pleasant, TX (US)

Correspondence Address: MAIER & MAIER, PLLC, 1000 DUKE STREET, ALEXANDRIA, VA, 22314, US

(21) Appl. No.: 12/285,594

(22) Filed: Oct. 9, 2008

Related U.S. Application Data
(60) Provisional application No. 60/960,723, filed on Oct. 11, 2007.

(51) Int. Cl. F21L 2/00; F21L 4/00

(52) U.S. Cl. 362/110; 362/208

(57) ABSTRACT

An exemplary embodiment discloses a hand-held multi-purpose flashlight that may include a real-time video display incorporated into a flashlight. The real-time video capabilities, housed within the flashlight casing, allow a user to view in low light environments as well as around corners and over and around obstructions. The multi-purpose flashlight may be equipped with an adjustable display screen on a back end that is adjustable in multiple directions and angles independent of the main body of the flashlight.

### PRIORITY

This application claims priority, under 35 U.S.C. 120, to U.S. Provisional Patent Application No. 60/960,723, filed on Oct. 11, 2007 and which is hereby incorporated by reference in its entirety.

### BACKGROUND

Flashlights are useful devices employed by various professions, such as police, firemen, military, and even maintenance workers. These flashlights may be used in investigative applications in low lit areas as well as in emergency situations that may be hazardous, due to power failure or other disasters. Flashlights have also become a personal or family necessity in daily life. The lighting provided by a flashlight has brought convenience to users in many respects. Flashlights are often used when camping, searching through basements, storage areas or other potentially low lit areas and during many different nighttime activities.

Recently, the runtime of flashlights has been extended with the help of advances in electronic technology, such as by using a low-power and high-brightness light emitting diode (LED) as the light source. LED lights can provide an efficient alternative to conventional light bulbs historically utilized by flashlights.

Flashlights have also been combined with cameras as a means of taking still pictures and having a light source in a single device. These devices are generally simple combinations of flashlights and still-picture cameras. Such devices generally require that the light from the flashlight be turned off during the time a picture is being taken in order to reduce wash out of the picture.

### SUMMARY

An exemplary embodiment discloses a hand-held multi-purpose flashlight that may include a real time display incorporated into a flashlight. The real-time video capabilities, housed within the flashlight casing, allow a user to view in low light environments as well as around corners and passed other obstructions. The multi-purpose flashlight may be equipped with an adjustable display screen on a back end that is adjustable in multiple directions and angles independent of the main body of the flashlight.

Another exemplary embodiment discloses a multi-purpose flashlight that may include a real-time video display incorporated into a flashlight. The real-time video capabilities, housed within the flashlight casing, allow a user to view in low light environments as well as around corners and other difficult obstructions. The multi-purpose flashlight may be equipped with an adjustable display screen on a back end that is adjustable in multiple directions and angles independent of the main body of the flashlight. Additionally, the flashlight may have integrated heat/thermal indication capabilities. The flashlight may also be conformed to mount onto standard tactical weapons employed be military, law enforcement and other rescue and emergency units.

Another exemplary embodiment discloses a multi-purpose flashlight system that may include a real-time video display incorporated into a flashlight. The real-time video capabilities, housed within the flashlight casing, allow a user to view in low light environments as well as around corners and other difficult obstructions. The multi-purpose flashlight may be equipped with an adjustable display screen on a back end that is adjustable in multiple directions and angles independent of the main body of the flashlight. On/off switches for the light and the video may be configured to permit one-hand operation of both the video and the light, for both left and right-handed users. Additionally the on/off switch for the video may have two-stage operability for momentary and continuous use.

### BRIEF DESCRIPTION OF THE DRAWINGS

Advantages of embodiments will be apparent from the following detailed description of the exemplary embodiments, which description should be considered in conjunction with the accompanying drawings in which like numerals indicate like elements, in which:

FIG. 1 is an exemplary perspective view of an exemplary embodiment of a multi-purpose flashlight with a collapsed display.

FIG. 2 is an exemplary perspective view of an exemplary embodiment of a multi-purpose flashlight with an extended display.

FIG. 3 is an exemplary detailed side view of an exemplary embodiment of a multi-purpose flashlight with an extended screen.

FIG. 4 is an exemplary perspective view of another exemplary embodiment of a multi-purpose flashlight with a weapon mount.

FIG. 5 is an exemplary perspective view of another exemplary embodiment of a multi-purpose flashlight with a weapon mount and an extended display.

### DETAILED DESCRIPTION

Aspects of the multi-purpose flashlight are disclosed in the following description and related drawings directed to specific embodiments. Alternate embodiments may be devised without departing from the spirit or the scope of the invention. Additionally, well-known elements of exemplary embodiments will not be described in detail or will be omitted so as not to obscure the relevant details. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments of the multi-purpose flashlight include the discussed feature, advantage or mode of operation.

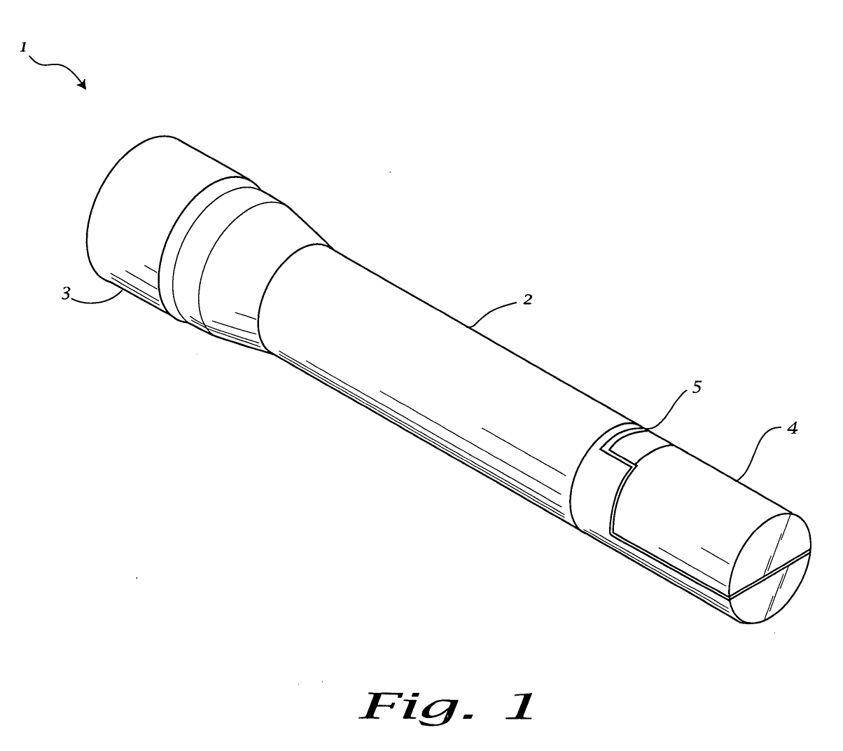

An exemplary embodiment of a multi-purpose flashlight 1, as shown in FIGS. 1-5, may include a main body 2. The main body 2 may be enhanced with a non-glare grip, rubber grip, ribbed grip or any other gripping mechanism that may be employed on the main body 2 with positional ergonomics. The main body 2 may vary in length and width according to any desired dimension and may also have a form factor consistent with a conventional flashlight.

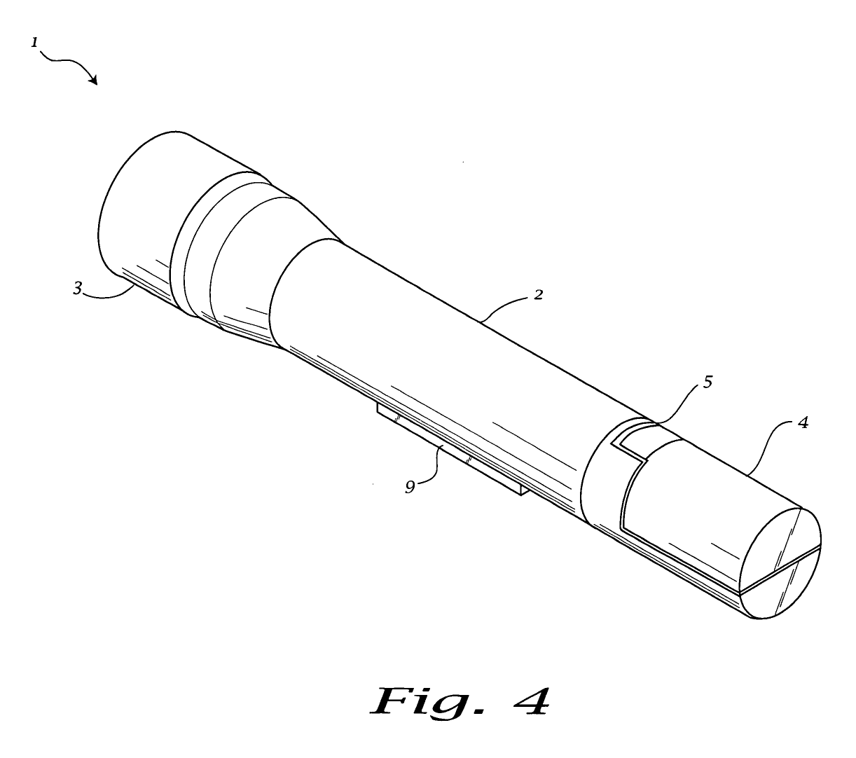

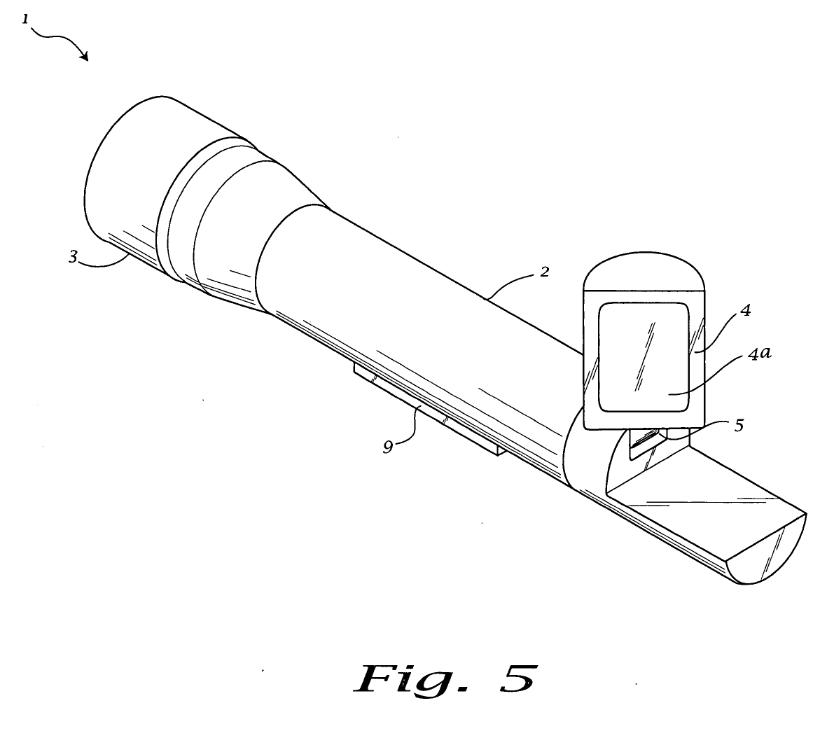

An exemplary embodiment of a multi-purpose flashlight 1 may also be composed according to extremely durable design for heavy use in rugged conditions. This composition may also a mount 9, as shown in FIGS. 4 and 5, for easy attachment to standard issue ASP batons and other desired weaponry, as a means of providing additional visual manipulations and extension. This mount 9 and rugged design may create a durable and useful design for military, law enforcement or any other desired user. The mount 9 may include elements such as, for example, an extending bracket, bolt holes, pegs, tongue and groove elements or any other desired mounting mechanism that may facilitate mounting a multi-purpose flashlight 1 to a weapon or other desired element or tool.

An exemplary embodiment of the multi-purpose flashlight 1 may be powered by disposable or rechargeable batteries or any other desired portable power source. The number of batteries and the output voltage of the batteries may vary according to a desired power output capability. The power source may be used to power each of the electronic devices incorporated into the multi-purpose flashlight 1. The electronic devices may include a light source, real-time video, thermal/heat indicator/detector and any other desired auxiliary electronic components.

An exemplary light source may include a conventional flashlight light bulb, redundant IR and visible light emitting devices (LEDs) or any other desired light emitting mechanism. In the use of the redundant IR and visible LEDs, the loss of a single LED may not adversely affect the overall lumination performance of the multi-purpose flashlight 1. The visible light output by the exemplary light source may exceed 90 lumens or emit fewer lumens depending on the desired lumen output.

The exemplary embodiments shown in FIGS. 1-5 may also include a real-time video camera. This video camera may be fully enclosed within the main body 2 of the multi-purpose flashlight 1. The video camera may include a low-lux, wide angle camera lens or any other desired camera lens that can be incorporated into the head 3 of the flashlight 1. The head 3 may incorporate the video camera lens, a light source and a thermal detection device. The video camera may be capable of recording images and audio sound, via a microphone or other audio detection device, onto a memory storage device and may also be capable of relaying a real-time image and sound to a screen 4 at a back end of the flashlight 1. The flashlight 1 may also include speakers which may be used to transmit recorded audio tracks recorded by the audio detection device. The video camera may also be capable of viewing and recording images in darkness through the use of inferred technology or other desired night-viewing technology. Infrared LEDs housed within the flashlight 1 may be used to provide lighting for capturing images in the low light. A user may switch between the normal light and lowlight modes.

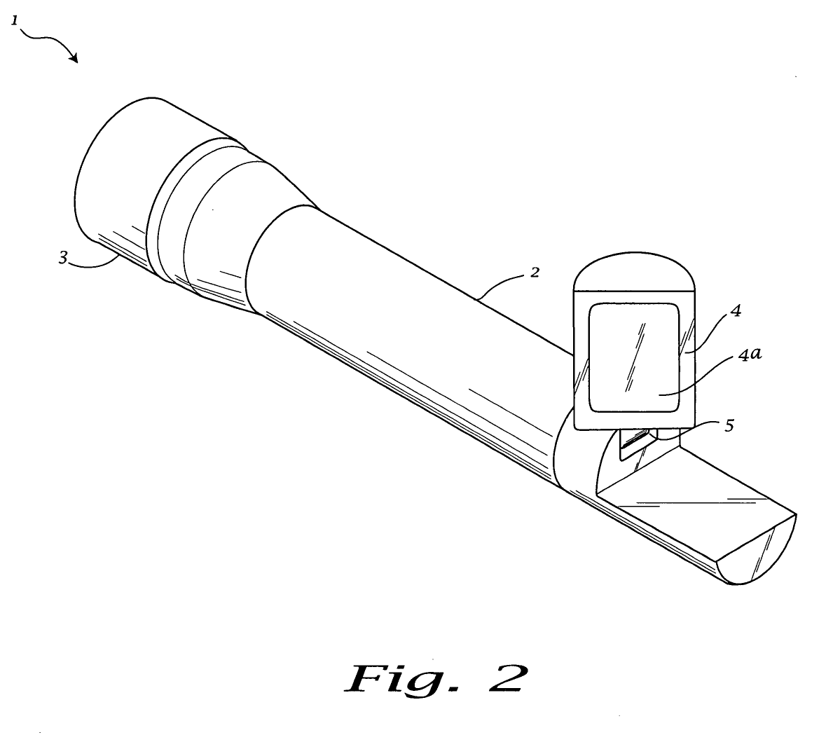

The display 4 may be attached to the back end of the flashlight 1 by a hinge 5 or other attachment mechanism. The hinge 5 may be capable of positioning the display 4 in any desired direction or any angle through 360 degrees. This hinge 5 may allow a user to see around corners or passed obstructions and may provide easy use for both left-handed and right-handed users. The display may include a screen 4a that may be made of a liquid crystal display (LCD), plasma or any other desired image display mechanism. The display 4 may be extended in a position, as seen in FIGS. 2, 3 and 5, which is perpendicular to the main body 2 or collapsed in a position, as seen in FIGS. 1 and 4, which may be parallel and flush with the main body 2. The collapsed position may reduce the likelihood of damaging or dislocating the display 4 while utilizing the rugged construction of the flashlight 1.

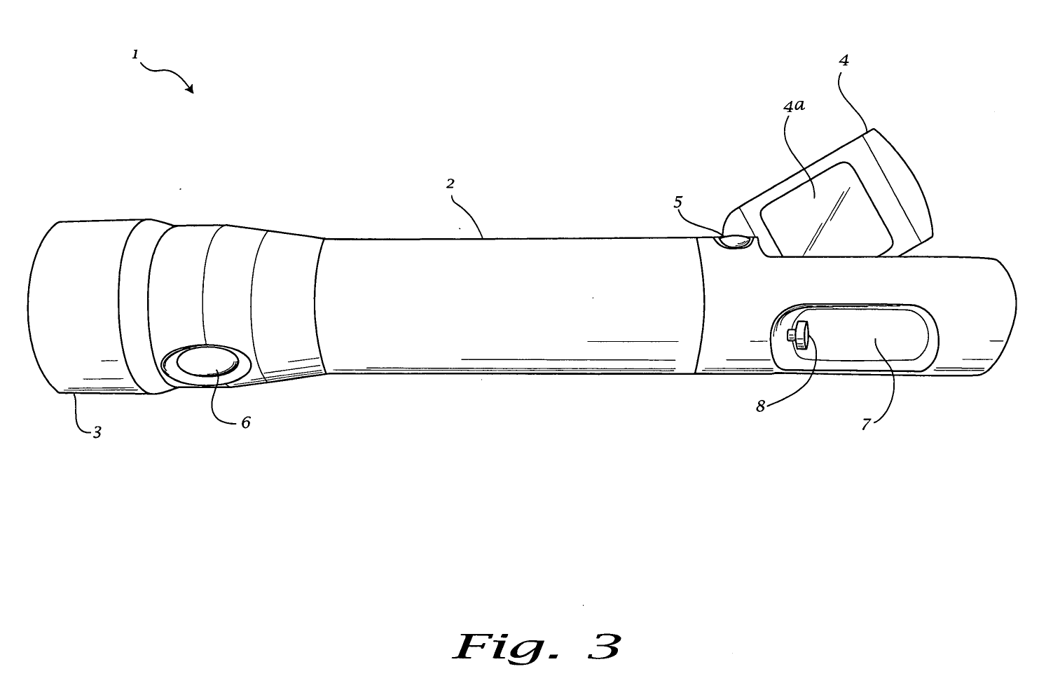

As shown in another exemplary embodiment in FIG. 3, the multi-purpose flashlight may include an on/off switch 6 for the light source and an on/off switch 8 for the video camera. The switch 6 for the light source may be located at a front end of the flashlight 1 adjacent to the head 3 or at any other desired position along the length of the main body 2. The switch 6 may be a button type press switch, a laterally movable switch (flip switch) or any desired switch capable of controlling the flow of power to the light source.

The switch 8 for the video camera may be located at a back end of the flashlight 1 or at any other position along the length of the main body 2. The switch 8 may also be located within a recess 7, which may also be located at the back end of the flashlight 1 or at any other position along the length of the main body 2. The recess 7 may aide in preventing accidental activation of the video camera device. The switch 8 may be a simple on/off type switch, two-stage switch capable of momentary or continuously dedicated video usage or any other desired switch capable of controlling the flow power and operation of the video camera.

In another exemplary embodiment a multi-purpose flashlight 1 may include a thermal detection device. The thermal detection device may include a thermal sensor which may be located in or adjacent the head 3 or positioned at any other location long the length of the main body 2. Additionally, the thermal detection device may include a thermal detection indicator which may relay or transmit a thermal reading or thermal image to screen 4a or to the user through the use of a screen, light or other desired indicating mechanism.

Exemplary embodiments of the multi-purpose flashlight 1 may enhance safety for officers of the military, law enforcement, search and rescue and other users through the following scenarios: traffic contacts, vehicle searches, building/room entry, wooded environments, faster and safer location of suspects or victims and improving officer safety during lock down enforcement and emergencies. Additionally, a multi-purpose flashlight 1 may improve intelligence gathering due to ease of operation and positional advantages, as well as, enhance night time and low light vision, functions in smoke filled environments and under intelligence or surveillance situations.

The foregoing description and accompanying drawings illustrate the principles, preferred embodiments and modes of operation. However, the claimed subject matter should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A multi-purpose flashlight comprising:
a main body, wherein the main body has a first and a second terminal end;
a light emitting element attached to the first terminal end;
a real-time video recorder attached to the first terminal end; and
a video display attached to the second terminal end, wherein the video display displays real-time video images transmitted by the real-time video recorder.

2. The multi-purpose flashlight of claim 1, wherein the video display is extendable away from the main body.

3. The multipurpose flashlight of claim 2, wherein the video display is flush with the main body when the video display is not extended.

4. The multi-purpose flashlight of claim 1, further comprising:
a hinge, wherein the hinge attaches the video display to the main body.

5. The multi-purpose flashlight of claim 4, wherein the video display is rotatable 360 degrees, independent of the main body, via the hinge.

6. The multi-purpose flashlight of claim 1, further comprising:
a mounting element, wherein the mounting element facilitates mounting the flashlight to a weapon.

7. The multi-purpose flashlight of claim 1, wherein the real-time video recorder records images in low-light environments.

8. The multi-purpose flashlight of claim 1, further comprising:
a thermal variation indicator, wherein the thermal variation indicator transmits a thermal variation output to the display screen.

9. The multi-purpose flashlight of claim 1, further comprising:
an on/off switch attached to the main body, wherein for the on/off switch provides two-stage operability for momentary and continuous use of the real-time video recorder.

10. A multi-purpose flashlight comprising:
a main body, wherein the main body has a first and a second terminal end;
a light emitting element attached to the first terminal end;
a thermal variation indicator, wherein the thermal variation indicator transmits a thermal variation output to the display screen
a real-time video recorder attached to the first terminal end; and
a video display attached to the second terminal end, wherein the video display displays a thermal variation output transmitted from the thermal variation indicator.

11. The multi-purpose flashlight of claim 10, wherein the video display is extendable away from the main body.

12. The multipurpose flashlight of claim 11, wherein the video display is flush with the main body when the video display is not extended.

13. The multi-purpose flashlight of claim 10, further comprising:
a hinge, wherein the hinge attaches the video display to the main body.

14. The multi-purpose flashlight of claim 13, wherein the video display is rotatable 360 degrees, independent of the main body, via the hinge.

15. The multi-purpose flashlight of claim 10, further comprising:
a mounting element, wherein the mounting element facilitates mounting the flashlight to a weapon.

16. The multi-purpose flashlight of claim 10, further comprising:
a real-time video recorder attached to the first terminal end, wherein the video display displays real-time video images transmitted by the real-time video recorder.

17. The multi-purpose flashlight of claim 16, wherein the real-time video recorder records images in low-light environments.

18. The multi-purpose flashlight of claim 16, further comprising:
an on/off switch attached to the main body, wherein for the on/off switch provides two-stage operability for momentary and continuous use of the real-time video recorder.
